(19) United States
(12) Patent Application Publication
(10) Pub. No.: US 2003/0128672 A1
(43) Pub. Date: Jul. 10, 2003

(54) Transmission and flow control

(76) Inventors: Sridhar Komandur, Richardson, TX (US); Janet H. Lind, Plano, TX (US); Jogen K. Pathak, Irving, TX (US); Rangaprasad Govindarajan, Plano, TX (US); Shridhar Krishnamurthy, Coppell, TX (US)

Correspondence Address: R. Scott Rhoades, Strasburger & Price, L.L.P., Suite 4300, 901 Main Street, Dallas, TX, 75202-3794, US

(21) Appl. No.: 10/364,179

(22) Filed: Feb. 11, 2003

Related U.S. Application Data
(63) Continuation-in-part of application No. 10/289,659, filed on Nov. 7, 2002.
(63) Continuation-in-part of application No. 09/884,663, filed on Jun. 19, 2001.
(60) Provisional application No. 60/356,380, filed on Feb. 11, 2002.

(51) Int. Cl. H04B 7/14

(52) U.S. Cl. 370/315; 370/324

(57) ABSTRACT

A system, method, and apparatus for transmitting packet data over a wireless network to a mobile station is presented herein. Packet data are received at a wireless content switch that is part of the wireless data network. The wireless content switch is equipped to detect lost packets, lost acknowledgments, and take appropriate remedial action, without invoking the congestion control and avoidance mechanisms of the transmission control protocol.

### CROSS-REFERENCE TO RELATED APPLICATIONS

This application claims the priority benefit of U.S. Provisional Applications for patent Ser. No. 60/356,380, entitled “Wireless Optimized TCP,” filed Feb. 11, 2002 and is a continuation-in-part of U.S. patent application Ser. No. 09/884,663 entitled “Packet Retransmission in a Wireless Packet Data Networks,” filed on Jun. 19, 2001, and is a continuation-in-part of U.S. patent application Ser. No. 10/289,659 entitled “Retransmission Control in Wireless Packet Data Networks,” filed on Nov. 7, 2002, all of which are hereby incorporated by reference for all purposes.

### STATEMENT REGARDING FEDERALLY SPONSORED RESEARCH/DEVELOPMENT

Not Applicable

### FIELD

The present application is related to wireless packet data networks, and more particularly to transmission and flow control in wireless packet data networks.

### BACKGROUND

Wireless networks are increasingly being used for accessing the Internet. Wireless packet data protocols such as Universal Mobile Telecommunications System (UMTS), General Packet Radio Service (GPRS) and EDGE were developed to facilitate the transmission of data packets over the wireless network.

The Internet is a global network connecting computers from government agencies, educational institutions, the military, and businesses from around the world. Data is transmitted over the Internet using data packets. The data packets are sent from a sender to a recipient over any one of a number of network connections between the sender and recipient. Unlike a switched network, no dedicated connection between the sender and recipient is established. In contrast, the packets are sent from the sender with an address associated with the recipient, such as an Internet Protocol address (IP address) over any one of a number of available paths between the sender and recipient.

Due to the lack of a dedicated path between the recipient and the sender, the requisite time of transmission can vary from packet to packet. Additionally, during periods of high congestion, data packets can also be dropped by an intermediate router. The foregoing considerations necessitate a means of providing the sender with a confirmation that the transmitted data packets are received. The Transmission Control Protocol (TCP) provides for the use of acknowledgment messages between the recipient and the sender, responsive to receipt of a data packet.

TCP initially causes the transmission rate to ramp-up in a sliding window at the beginning of a packet flow, which is called the slow-start mode. After reaching a threshold on the sliding window size, TCP slowly increases the transmission rate in a linear fashion, which is called the congestion-avoidance mode. The rate is continuously increased until there is a loss or time-out of the packet receipt acknowledgment message. TCP then “backs off”, decreasing the transmission window size, and then retransmits the lost packets in the proper order at a significantly slower rate. TCP assumes that packet losses are due to congestion and implements a slow start upon packet loss.

As noted above, TCP assumes that lost packets are due to network congestion. In wired networks, which are characterized by low bit error rates, the assumption is accurate. However, wireless networks are characterized by comparatively higher bit error rates, limited bandwidth, radio interference, and intermittent hand-offs, that are different from wired networks. The higher bit error rates, radio interference, and intermittent hand-offs cause more packet losses. The assumption that packet losses are due to congestion becomes inaccurate.

In the presence of the high bit error rates and intermittent connectivity characteristic of wireless links, TCP reacts to packet losses in the same manner as in the wired environment. The transmission window size is lowered before retransmitting packets and congestion control and avoidance mechanisms are invoked. The foregoing measures result in an unnecessary reduction in the wireless link's bandwidth utilization, thereby causing a significant degradation in performance in the form of poor throughput and very high interactive delays.

Modifications to the TCP protocol are often infeasible because of the necessary changes that would have to be made to the large number of existing servers and clients. A number of proposals have been made to alleviate the aforementioned degradation in performance, such as using a split connection, fast retransmit, and caching packets at the base station.

The Indirect-TCP (I-TCP) uses a split connection approach that involves splitting a TCP connection between a fixed and mobile host into two separate connections at the base station. The first connection is a TCP connection between the base station and the fixed host, while the second is between the base station and the mobile station. Because the second connection is a one-hop wireless link, a more optimized wireless link-specific protocol is used. Although I-TCP advantageously separates flow and congestion control of the wireless link from that of the fixed network, there are also a number of drawbacks. For example, I-TCP acknowledgments and semantics are not end-to-end. Additionally, applications running on the mobile station have to be relinked with the I-TCP library and need to use special I-TCP socket system calls. As well, packets need to go through the TCP protocol stack and incur the associated overhead four times—once at the sender, twice at the base station, and once at the receiver.

The fast retransmit approach addresses the issue of faster response to packet loss (instead of waiting for timeout) and quick rampup of the sliding window. Problems associated with handoffs are mitigated by having the mobile station send a certain threshold number of duplicate acknowledgments to the sender, causing the sender to immediately reduce the window size and retransmit packets starting from the first missing packet. The main drawback of the fast retransmit approach is that the sliding window is cut in half.

Balakrishnan, et. al., in “Improving TCP/IP Performance over Wireless Network”, proceedings 1st ACM International Conference on Mobile Computing and Networking, November 1995, proposes a transport protocol wherein packets are cached at the base station. Lost packets are retransmitted locally over the wireless link, thereby hiding packet loss over the wireless link from the fixed host. However, the transport protocol requires modifications of the network layer software at the base station and the mobile station.

Accordingly, it would be desirable to alleviate the performance degradation brought on by TCP congestion control and avoidance mechanisms in response to lost data packets over wireless links in a seamless manner with minimal modifications to the preexisting infrastructure.

### SUMMARY

Presented herein is a system and method for transmitting packet data over a wireless network to a mobile station. A wireless content switch is interposed between the wireline network and the mobile station. The wireless content switch monitors the transmissions and detects lost data packets and lost acknowledgments based on the received data packets and acknowledgments.

The wireless content switch optimizes the wireless network through the implementation of various optimization schemes, including, but not limited to optimized TCP retransmissions, content server persist control, transmission rate regulation, expedited congestion window increases after the server has timed out, and improved goodput of the mobile station. These optimization schemes improve the overall quality of service and quality of experience by reducing redundant transmission over the wireless interface and by timely transmissions of control signals to the content server.

### BRIEF DESCRIPTION OF THE DRAWINGS

For a more complete understanding of the present invention, and for further details and advantages thereof, reference is now made to the following Detailed Description taken in conjunction with the following drawings, in which:

FIG. 1 is a block diagram of an exemplary data communication system;

FIG. 1A is a block diagram of an exemplary wireless content switch;

FIG. 2 is a flow diagram describing the operation of the wireless content switch;

FIG. 2A is a flow diagram describing the determination of whether a received packet is in sequential order by the wireless content switch;

FIG. 3 is a signal flow diagram describing the operation of the system, wherein data packets are transmitted from content source to mobile station;

FIG. 4 is a signal flow diagram describing the operation of the system wherein a data packet is lost in the wired network;

FIG. 5 is a signal flow diagram describing the operation of the system wherein a data packet is lost in the wireless air interface;

FIG. 6 is a signal flow diagram describing the operation of the system wherein a lower order data packet is received;

FIG. 6A is a signal flow diagram describing the operation of the system wherein the radio link is down;

FIG. 6B is a signal flow diagram describing the operation of the system wherein the radio link is found to be operational;

FIG. 6C is a signal flow diagram describing the operation of the wireless content switch wherein an acknowledgment is received;

FIG. 7 is a flow diagram describing the “eat the packet” function during retransmission;

FIG. 8 is a flow diagram describing the “drain the packet” function during retransmission;

FIG. 9 is a flow diagram describing the optimized TCP function during retransmission;

FIG. 10 is a flow diagram describing the persist server function during periods of mobile unavailability;

FIG. 11 is a flow diagram describing the buffer trigger rate regulation function during packet transmission;

FIG. 12 is a flow diagram describing the expedited congestion window increase function during retransmission; and

FIG. 13 is a flow diagram describing the improved goodput function during packet transmission.

### DETAILED DESCRIPTION OF THE DRAWINGS

In the descriptions which follow, like parts are marked throughout the specification and drawings with the same numerals, respectively. The drawing figures are not necessarily drawn to scale and certain figures may be shown in exaggerated or generalized form in the interest of clarity and conciseness.

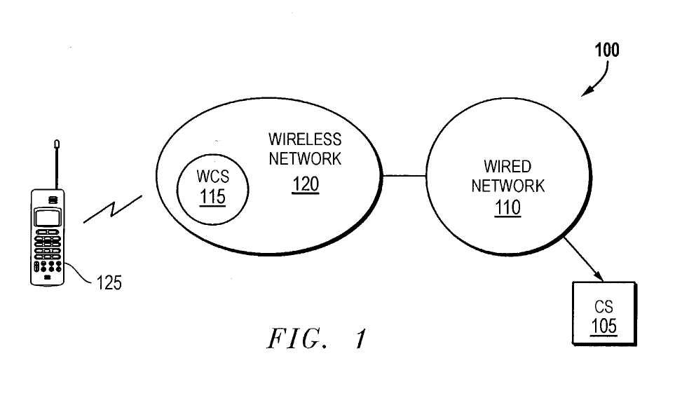

Referring now to FIG. 1, there is illustrated a conceptual diagram of a communication system, referenced generally by the numeric designation 100, for sending data packets from content source 105 to a mobile station 125. The content source 105 is a server providing information which can comprise, for example, a web server, email server, ftp server, database server, streaming audio/video server, or an application server.

Information from the content source 105 is transmitted in the form of numbered data packets over a wired network 110, wherein each data packet is associated with a packet number. The wired network 110 is a packet data wireline communication system which can comprise, for example, a local area network, a wide area network, or the Internet. The wired network 110 transmits the data packets to a wireless network 120 associated with the mobile station 125 via a wireless-content switch 115.

The wireless network 120 comprises any communication network which can transmit packet data over a wireless air interface. For example, the wireless network 120 can comprise cellular data networks, such as the Code-Division Multiple Access (CDMA), the Global System for Mobile Communications (GSM) or the Personal Communication System (PCS), equipped to transmit packet data in accordance with the Universal Mobile Telecommunications System (UMTS), General Packet Radio Service (GPRS) or EDGE protocols. The wireless network 120 transmits the packet data over the wireless air interface to the mobile station 125.

A wireless content switch 115 receives packets in wireless network data formats (for example, GPRS Tunneling Protocol (GTP) format packet data) and can determine additional processing that may be required based upon the mobile station 125, and the type of content in the packet, priority data, quality of service data, multicasting functionality, or other suitable functions. In one disclosed embodiment, the wireless content switch is an Intelligent Packet Control Node (IPCN) developed and manufactured by Cyneta Networks, Inc.

The wired network 110 uses the Transmission Control Protocol (TCP) which provides for the use of acknowledgment messages to the content source 105, responsive to receipt of the data packet. Upon receipt of the data packets, acknowledgments are sent which indicate the last contiguous data packet received. For example, wherein data packets P(1) . . . P(N) are received, followed by P(N+2) . . . P(N+T), wherein T is a predetermined threshold, an acknowledgment indicating P(N) will be sent responsive to receipt of P(N+T). The acknowledgment indicating P(N) after transmission of P(N+T) is considered duplicative acknowledgment. As noted above, TCP assumes that lost packets are due to network congestion. In the wired network 110, which is characterized by low bit error rates, the assumption is accurate. However, the air interface between the mobile station 125 and the wireless network, 120 is characterized by comparatively higher bit error rates, limited bandwidth, radio interference, and intermittent hand-offs. The higher bit error rates, radio interference, and intermittent hand-offs cause more packet losses. The assumption that packet losses are due to congestion becomes inaccurate.

The wireless content switch 115 receives the data packets sent from the content source 105 and forwards the data packet to the mobile station 125. Prior to forwarding the packet to the mobile station 125, the wireless content switch 115 stores the data packet. When the mobile station 125 receives data packets, the acknowledgments transmitted from the mobile station 125 are received by the wireless content switch 115.

As noted above, the acknowledgments transmitted from the mobile station 125 are indicative of the last contiguous packet received, thereat. Therefore, the receipt by the wireless content switch 115 of duplicative acknowledgments are indicative of lost packets between the wireless air interface and the mobile station 125.

Responsive thereto, the wireless content switch 115 can retransmit the missing data packet to the mobile station 125 or execute “eat the packet” or “drain the packet” functions which are disclosed herein. Upon receipt of the missing packet, the mobile station 125 transmits an acknowledgment to the wireless content switch 115. The wireless content switch 115 then forwards the acknowledgment to the content source 105. In the foregoing manner, TCP congestion control and avoidance is prevented from occurring due to the loss of a data packet over the wireless air interface.

During packet transmission and retransmission, the wireless content switch 115 implements various optimization schemes, including but not limited to optimized TCP retransmissions, content server 105 persist control, transmission rate regulation, expedited congestion window increases after the server has timed out, and improved goodput of the mobile station 125. These optimization schemes improve the overall quality of service and quality of experience by reducing redundant transmission over the wireless interface and by timely transmissions of control signals to the content server 105. These optimization schemes are discussed more fully herein.

Referring now to FIG. 1A, there is illustrated a block diagram of an exemplary wireless content switch 115. The wireless content switch 115 includes any number of upstream ports 150a and downstream ports 150b. The upstream ports 150a facilitate connection of the wireless content switch 115 towards the content source 105 via a trunk line, such as, for example, a T1, E1, or an Ethernet connection, to name a few. Connection of the wireless content switch 115 towards the content source 105 via the upstream port 150a permits, at the upstream port 150a, receipt and transmission of data packets, acknowledgments, and other signals to and from content source 105.

Similarly, the downstream ports 150b facilitate connection of the wireless content switch 115 towards the mobile station 125. Connection of the wireless content switch 115 towards the mobile station 125 via the downstream port 150b permits, at the downstream port 150b, receipt and transmission of data packets, acknowledgments, and other signals to and from the mobile station 125.

The wireless content switch 115 also includes memory 155 wherein packets received from the upstream port 150a are stored. In one embodiment, the memory 155 can comprise Shared Dynamic Random Access Memory (SDRAM). Packets received from upstream port 150a are transmitted along a bus 160 for storage into the memory 155. Data packets stored in the memory 155 are transmitted by forwarding the data packet from the memory 155 to the downstream port 150b via bus 160.

The memory 155 can also store executable instructions for execution by a processing unit 165. Until required by the processing unit 165, the instructions may be stored in another memory, for example in a hard disk drive 170, or in a removable memory such as an optical disk 175 for eventual use in a compact disk read only memory (CD-ROM) drive 180 or a floppy disk 185 for eventual use in a floppy disk drive 190. Examples of such executable instructions include the optimization and retransmission processes disclosed herein.

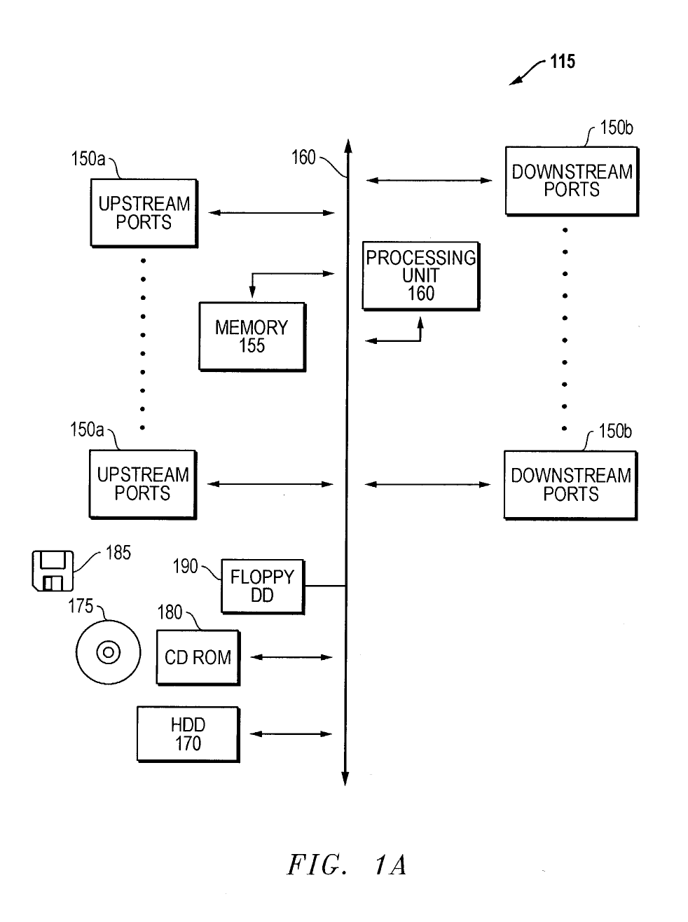

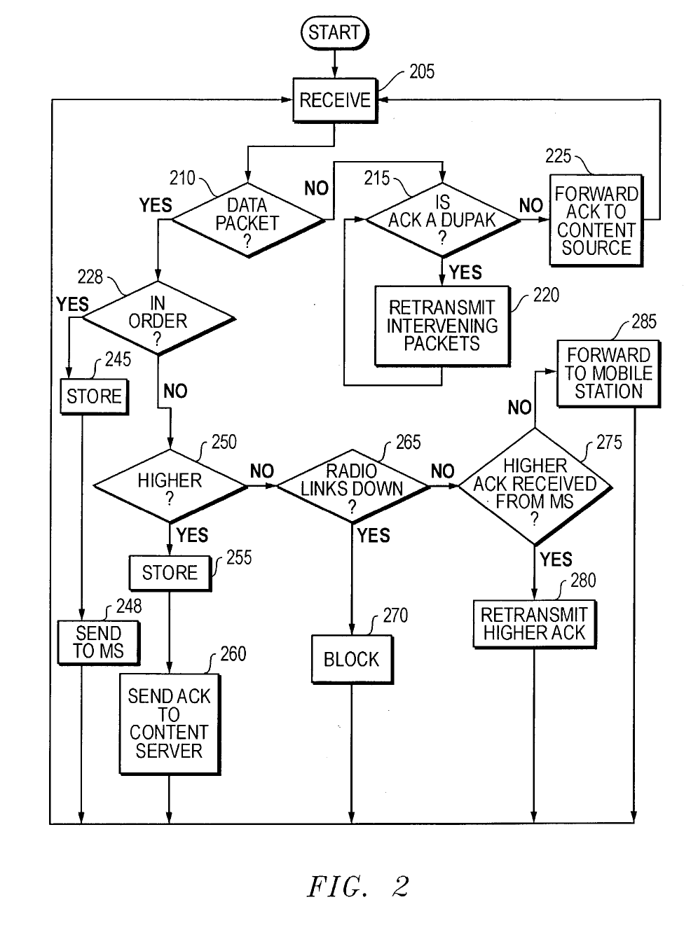

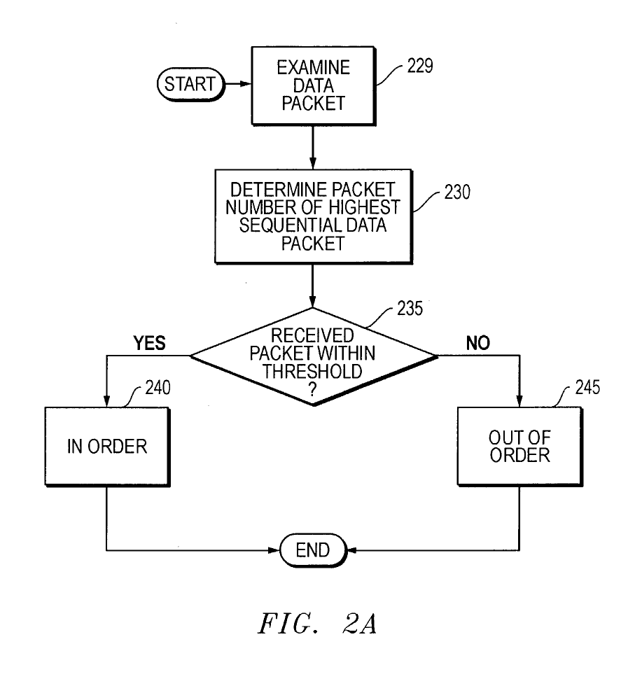

Referring now to FIG. 2, there is illustrated a flow diagram describing the operation of the wireless content switch, responsive to receiving a signal at a port 150 (step 205). At step 210, a determination is made whether the signal is an acknowledgment or a data packet. Wherein the received signal is an acknowledgment during step 210, a determination is made whether the acknowledgment is a duplicated acknowledgment or not (step 215).

Wherein the acknowledgment, e.g., A(I) was received before (known as a “duplicate acknowledgment”), the foregoing condition is indicative that data packets transmitted to the mobile station 125 after data packet P(I) were lost. Therefore, the packets after P(I) must be retransmitted. Accordingly, wherein the acknowledgment is a duplicate acknowledgment during step 215, the wireless content switch 115 retransmits (step 220) the intervening packets. As noted above, the wireless content switch 115 stores data packets in memory 155, prior to transmission to the wireless data network 120. Therefore, the wireless content switch can retrieve the intervening data packets from memory 155 and retransmit them via downstream port 150b. Wherein the acknowledgment is not a duplicate acknowledgment during step 215, the acknowledgment is forwarded to the content source 105 via upstream port 150a (step 225). Wherein the signal received during step 210 is a data packet, a determination is made whether the packet is in sequential order (step 228).

In another embodiment, after receipt of a duplicate acknowledgment signifying that the data packet transmitted to the mobile station 125 is lost, a determination of whether the lost data packet was a one packet scenario or a last packet scenario is made. A one packet scenario occurs when the session includes only one packet. The last packet scenario occurs when the session has only one packet left for transmission. If the duplicate acknowledgment is received and the one packet or last packet scenario occurs, then the “eat the packet” function may be implemented.

In another exemplary embodiment, if the mobile station becomes unreachable, the wireless content switch 115 stores the data packet in memory 155, prior to transmission to the mobile station 125. The wireless content switch 115 delays retransmission of the data packets until the reachability of the mobile station is determined. Once the mobile station is reachable, then a determination is made as to whether the retransmission timeout has occurred. If a retransmission timeout has occurred, then the “drain the packet” function can be implemented.

Referring now to FIG. 2A, there is illustrated a flow diagram describing the operation of the wireless content switch 115 in determining whether the received data packet is in sequential order. At step 229, the received data packet is examined. By examining the data packet, the wireless content switch 115 can determine a packet number associated with the received data packet. The packet number is related to the sequential order of the data packet in a sequence of data packets. The wireless content switch 115 then determines (step 230) the-packet number of the highest sequential data packet and compares (step 235) the packet number to the received data packet number.

It is noted that the Internet does not always deliver data packets in sequence. While a given packet, K+1, may be received prior to packet K, the foregoing condition is not necessarily due to the fact that packet K is lost or even excessively delayed. However, wherein a packet K+T is received prior to packet K, wherein T represents a predetermined threshold, there is a great likelihood that packet K is lost or excessively delayed between the content source 105 and the Internet content switch 115. Accordingly, during step 235, wherein the packet number of the received data packet is within a predetermined threshold, T, of the packet number of highest sequential data packet, a determination (step 240) is made that the packet is received in order. However, wherein the packet number of the received data packet is beyond the predetermined threshold, T, a determination (step 245) is made that the-data packet is received out of order.

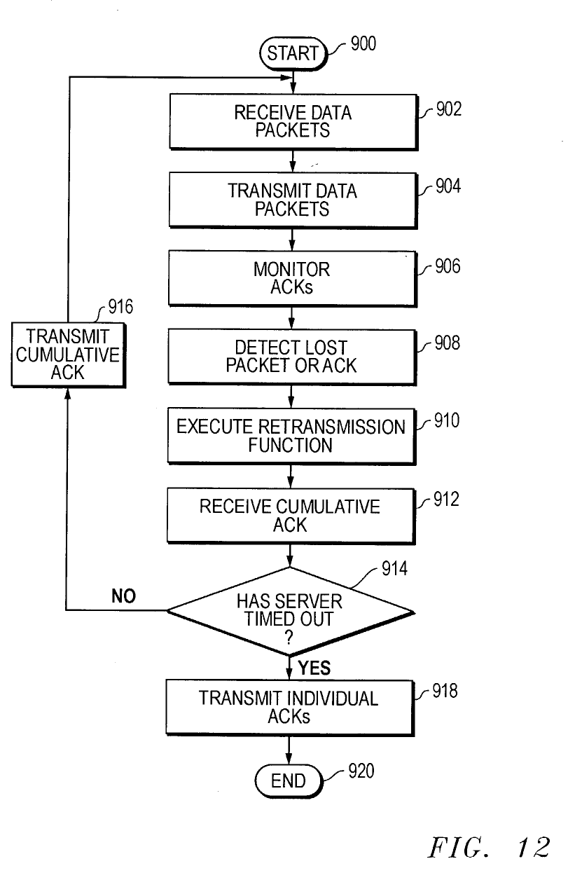

Referring again to FIG. 2, wherein the data packet is in sequential order, the data packet is stored by the wireless content switch 115 in memory 155 (step 246) and sent to the mobile station 125 via downstream port 150b (step 248). Wherein the data packet is not in sequential order, a determination is made whether the data packet is in higher sequential order or in lower sequential order (step 250). Wherein the data packet is in higher sequential order during step 250, the foregoing is indicative of data packets lost between the content source 105 and the wireless content switch 115. Therefore, the intervening data packets must be retransmitted to the wireless content source 115. Accordingly, the wireless content switch 115 stores (step 255) the data packets in memory 155 and transmits an acknowledgment via upstream port 150a (step 260) to the content source 105. The acknowledgment transmitted to the content source 105 indicates the last contiguous data packet received, thereby causing the content source 105 to retransmit the missing data packets.

Wherein the received data packets are in lower sequential order, the foregoing is indicative that the content source 105 has timed out prior to receiving appropriate acknowledgments. The wireless content switch 115 examines the wireless radio link conditions and determines (step 265) whether the radio link is down. Whether the radio link is down or not can be determined by, for example, using a handshake signal. Wherein the radio link is down, the received data packets are blocked (step 270).

Wherein the radio link is not down during step 265, a determination is made whether the wireless content switch 115 has received an acknowledgment of a higher packet number (step 275). Wherein an acknowledgment of a higher data packet has been received, the foregoing is indicative that an acknowledgment of a lower number data packet from the mobile station 125 has been lost. Accordingly, the acknowledgment of the higher data packet is retransmitted to the content source 105 (step 280). Wherein an acknowledgment of a higher data packet number has not been received, the data packets are retransmitted from memory 155 (step 285) to the mobile station 125. If the content server 105 has invoked the congestion control and avoidance mechanisms, the expedited congestion window increase functionality can be implemented at this time. This function is disclosed in association with FIG. 12.

The operation of the wireless content switch 115 is now described in certain exemplary scenarios. Referring now to FIG. 3, there is illustrated a signal flow diagram describing acknowledgment of sequential packets wherein the packets are received in order. Initially, the content source 105 transmits a setup signal 302 to the mobile station 125. The mobile station 125 then transmits a signal 303 containing a mobile station 125 identifier.

The content source 105 transmits information in the form of sequential data packets, wherein each data packet is associated with a particular sequential number, e.g., P(0) . . . P(I). The data packets are transmitted from the content sources 105 via the wired network 110 (signal 305), wireless content switch 115, and wireless network 120 to the mobile station 125. Upon receipt of a particular data packet, an acknowledgment is transmitted from the mobile station 125 which indicates the last contiguous packet. Therefore, wherein data packets P(0) . . . P(I) are received at the mobile station 125, responsive to receipt of data packet P(I), the mobile station transmits an acknowledgment, ACK(I) (signal 310).

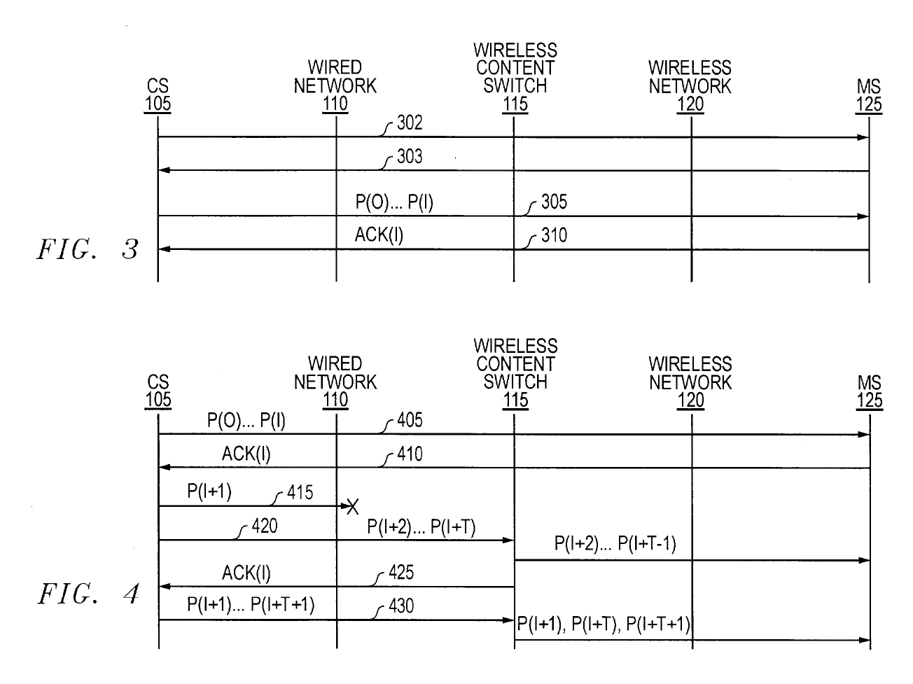

Referring now to FIG. 4, there is illustrated a signal flow diagram describing the operation of the system, wherein a data packet is lost in the wired network 110. The content source 105 transmits data packets P(0) . . . P(I) to the mobile station 125 (signals 405), and the mobile station 125 transmits acknowledgments (signals 410) to the content source 105. The content source 105 transmits data packets P(I+1) (signal 415) and P(I+2) . . . P(I+T) (signal 420) to wireless content switch 115 via upstream port 150a, wherein data packet P(I+1) is lost in the wired network 110. Responsive to receipt of data packet P(I+2) . . . P(I+T) at the wireless content switch 115, the wireless content switch 115 detects that data packet P(I+1) is lost. The wireless content switch 115 transmits an acknowledgment ACK(I) (signal 425) via upstream port 150a indicating that data packet P(I) was the last contiguous packet received.

Additionally, the wireless content switch 115 withholds transmission of data packet P(I+T) towards the mobile station 125. Responsive to receiving ACK(I), the content source 105, retransmits data packet P(I) with data packet P(I+T+1) (signal 430). Upon receipt of data packets P(I), P(I+T+1), the wireless content switch transmits data packets P(I+1), P(I+T), and P(I+T+1) (signals 435) to the mobile station 125 via downstream port 150a. Upon receipt of data packets P(I+1), P(I+2), and P(I+3), the mobile station 125 transmits acknowledgment (signal 440), ACK(I+3) indicating that every packet until P(I+3) has been received.

Referring now to FIG. 5, there is illustrated a signal flow diagram describing the operation of the system wherein a data packet is lost in wireless air interface between the wireless network 120 and the mobile station 125. The content source 105 transmits data packets P(0) . . . P(I) to the mobile station 125 (signals 505), and the mobile station 125 transmits acknowledgments (signals 510) ACK(0) . . . ACK(I) to the content source 105. The content source 105 proceeds to transmit data packet P(I+1) (signal 515) towards mobile station 125.

Data packet P(I+1) is received, stored in memory 155, and transmitted by wireless switch 115 towards mobile station 125. However, the data packet P(I+1) is lost in transmission between the mobile station 125 and the wireless network 120. Content server 105 proceeds to transmit data packets P(I+2) . . . P(I+T) to the mobile station 125 (signal 520). Upon receipt of data packet P(I+T), the mobile station 125 transmits an acknowledgment. However, because P(I+1) was not received by the mobile station 125, the last contiguous data packet is P(I). Accordingly, mobile station 125 transmits ACK(I) (signal 525).

The ACK(I) is received by the wireless content switch 115 at downstream port 150b. Responsive thereto, the wireless content switch 115 detects that data packet P(I+1) is stored at the wireless switch and was not received by the mobile station 125. Accordingly, the wireless content switch 115 retransmits the data packet P(I+1) from memory 155 to mobile station 125 via downstream port 150b (signal 530). Additionally, the wireless content switch 115 withholds transmission of ACK(I) to the content server 105, thereby preventing invocation of congestion control and avoidance mechanisms. When the mobile station 125 receives data packet P(I+1), the mobile station 125 transmits an acknowledgment ACK(I+T) (signal 535) to the wireless content switch 115 which is forwarded to the content source 105.

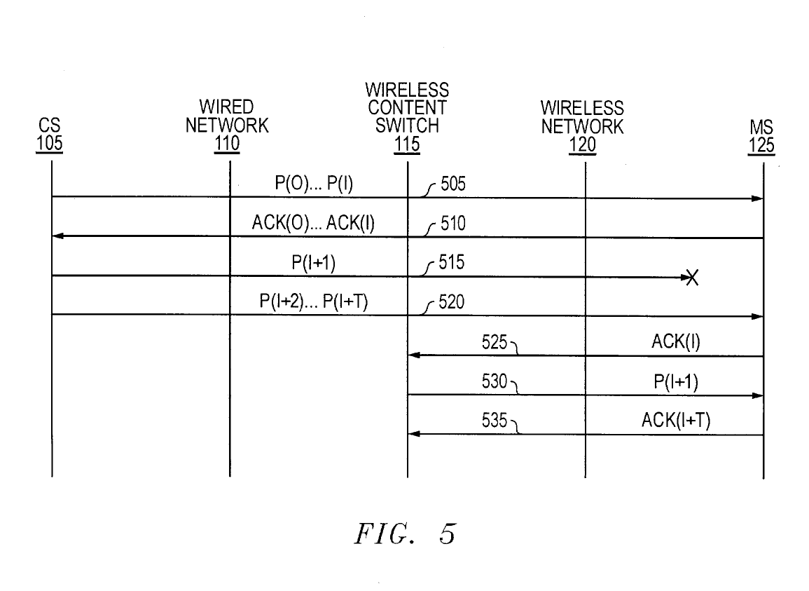

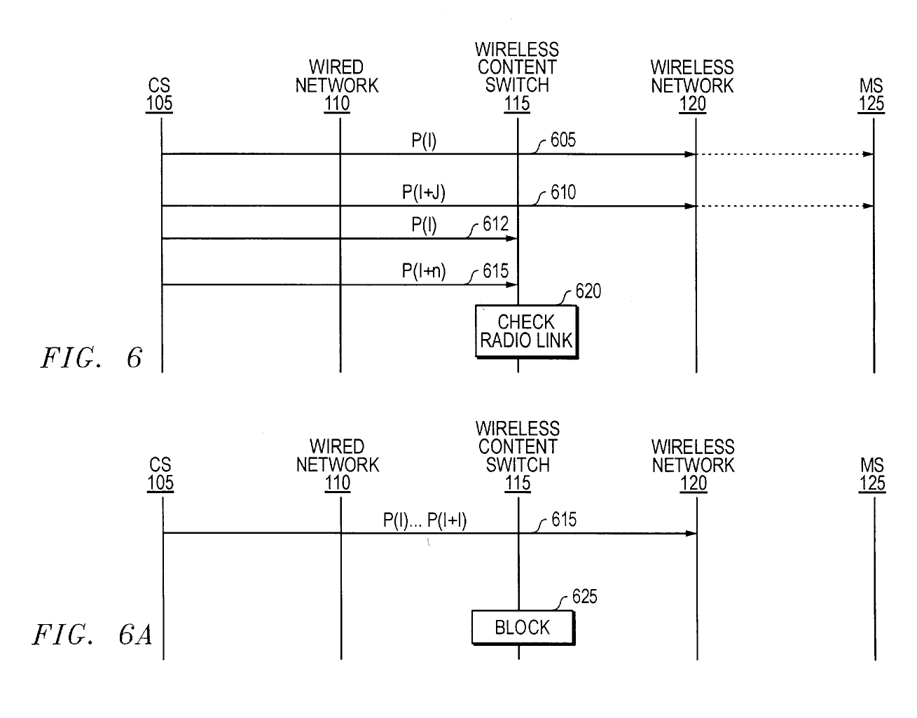

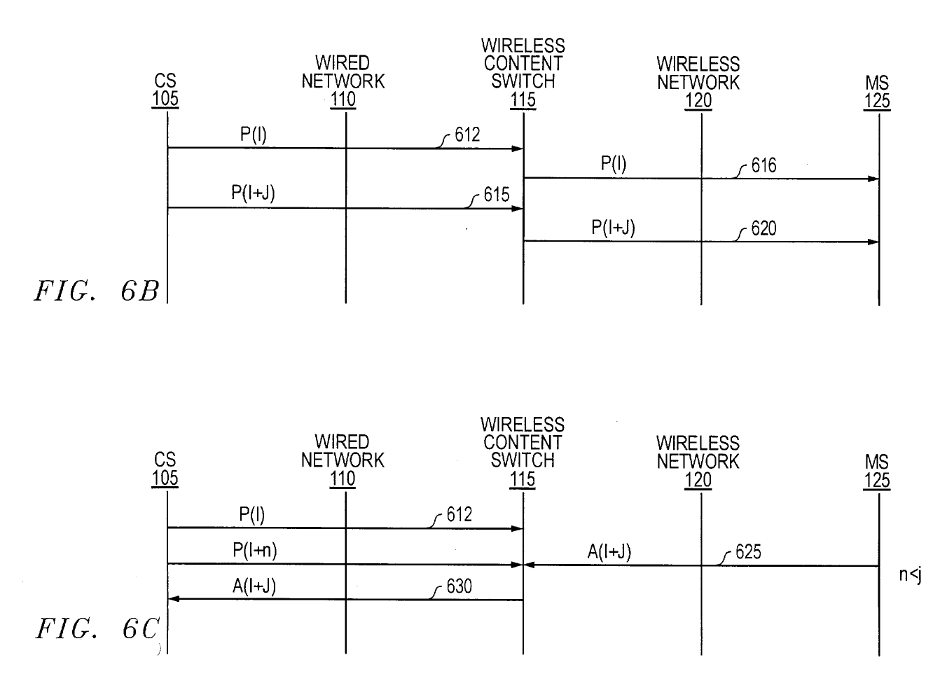

Referring now to FIG. 6, there is illustrated a signal flow diagram describing the operation of the wireless content switch 115, wherein lower ordered data packets are received by the wireless content switch 115 via upstream port 150a. Data packet P(I) through P(I+J) are transmitted from the content source 105 towards the mobile station 125 (signals 605, 610). After transmission of data packets P(I) to P(I+J) towards the mobile station 125, data packets P(I) . . . P(I+n), where n<=J, are again received at the wireless content switch (signals 612, 615) via the upstream port 105a.

The foregoing condition is indicative of a time out at the content source 105. The time out can either be caused by lost acknowledgments, a down radio connection between the wireless network 120 and the mobile station 125, or loss of data packets over the wireless network 120. Accordingly, the wireless content switch 115 examines the radio link and determines whether the radio link is up (action 620).

Referring now to FIG. 6A, there is illustrated a signal flow diagram describing the operation of the wireless content switch 115, wherein the wireless content switch 115 has detected that the radio link between the wireless network 120 and the mobile station 125 is down. Responsive to receipt of data packets P(I) . . . P(I+J) (signals 612, 615), the wireless content switch blocks (action 625) forward transmission of the data packets to the mobile station 125.

Referring now to FIG. 6B, there is illustrated a signal flow diagram describing the operation of the wireless content switch 115, wherein the radio link is determined to be operational. The wireless content switch 115 receives the data packets P(I) . . . P(I+J) (signal 612, 615) via upstream port 150a. The absence of any acknowledgment from the mobile station 125 is indicative of lost packets, P(I) . . . P(I+J) during the initial transmission (signals 605, 610). Accordingly, the wireless content switch 115 proceeds to retransmit the data packets P(I) . . . P(I+J) from memory 155 to the mobile station 125 (signals 616, 620) via downstream port 150b.

Referring now to FIG. 6C, there is illustrated a signal flow diagram describing the operation of the wireless content switch 115, wherein the radio link is determined to be operational. The wireless content switch 115 receives the data packets P(I) . . . P(I+n) via upstream port 150a (signals 612, 615). However, the wireless content switch 115 receives an acknowledgment, ACK(I+J), (signal 625) indicating receipt of each data packet until data packet P(I+J) via downstream port 150b. The foregoing is indicative of a lost acknowledgment. Accordingly, the wireless content switch 115 retransmits the acknowledgment (signal 630) via upstream port 150a to the content source 105. Transmission of the acknowledgment ACK(I+J) causes the content source to terminate transmission of the data packets prior to P(I+J).

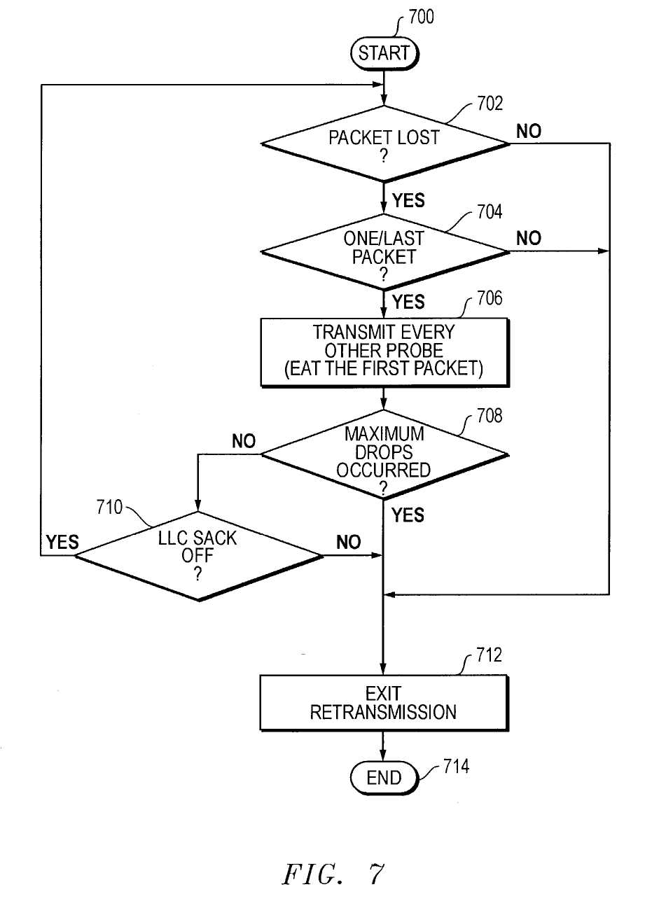

Referring now to FIG. 7, the flow diagram of the “Eat The Packet” (ETP) function during retransmission is shown. Retransmission control reduces unnecessary retransmission of data packets over the air interface. The flow diagram begins with start 700. Next in step 702, the determination of whether a packet has been lost in the transmission to the mobile station has occurred. The packet is lost if no acknowledgment signal is received from the mobile station for the last transmitted packet or if a duplicate acknowledged signal has been received for a previously transmitted packet. Conditions which are indicative of data packet losses can include, for example, detection of deterioration in the radio frequency wireless link, or detection of excessive buffer memory usage by a wireless client. If no packet is lost as determined in step 702, then the retransmission function exits at step 712 and ends with step 714. If a packet is determined to be lost in step 702, then whether the packet is a one packet transmission or a last packet transmission is determined. The one packet or last packet determination is made in step 704 by comparing the amount of data present in the data packet with the maximum amount of data that can be transmitted. If the amount of data is less than the maximum amount, then the situation is a one packet/last packet scenario. However, alternate implementations of determining the one packet or last packet scenario are available and can be implemented without detracting from the spirit of the invention. If the lost packet is not a one packet or last packet as determined in step 704, then the process continues with step 712 and the retransmission function is exited. If the lost packet is the one packet or last packet as determined in step 704, the wireless content switch (WCS) transmits every other probe received from the wired network to the mobile station. The first probe received from the wired network is discarded with the second probe being transmitted to the mobile station. By transmitting every other probe, the traffic over the degraded air interface is reduced. In most situations, the lost packet will eventually reach the mobile station and thus any excess probes and/or retransmissions of the one packet or last packet is unnecessary. Next, in step 708 the number of probe drops or discards is evaluated against the maximum drops allowable. If the number of probe drops is less than the maximum drops, then the process continues to step 710 where the determination of the Logical Link Control (LLC) selective acknowledgment (SACK) is observed. If the LLC SACK is off, then the process returns to step 702 and evaluation of whether the packet is lost occurs. If the maximum drops has been met as determined in step 708 or if the LLC SACK is not off as determined in step 710, then the process continues with step 712 and the retransmission function is exited. The function then ends with step 714.

The Eat The Packet functionality is disengaged for all active TCP sessions if the wireless network 120 enters the Asynchronous Disconnected Mode (ADM) state. The ADM state is entered as follows. After retransmissions of the exchange ID (XID) command N200 times (a variable configurable at initial set-up), the Logical Link Management Entity (LLME) indicates this to the GPRS Mobility Management (GMM) by means of a LLGMM-Status-Ind primitive, and, if the Logical Link Entity (LLE) is in the Asynchronous Balanced Mode (ABM) state, then the LLE sends an LL-Release-Ind (Cause=‘No Peer Response’) to layer 3 and enters the ADM state.

ABM Operation for SAPIs 1 (GMM), 2 (TOM2), 7 (SM), and 8 (TOM8) is not permitted.

An LLE initiates a request for release of the ABM operation by transmitting the DISC command with the P bit set to 1. Timer T200 is then set and the retransmission counter is reset. An LLE receiving a DISC command while in ABM state transmits a UA response with the F bit set to the same binary value as the P bit in the received DISC command. An LL-Release-Ind (Cause=‘Normal Release’) primitive is passed to layer 3, and the ADM state is entered.

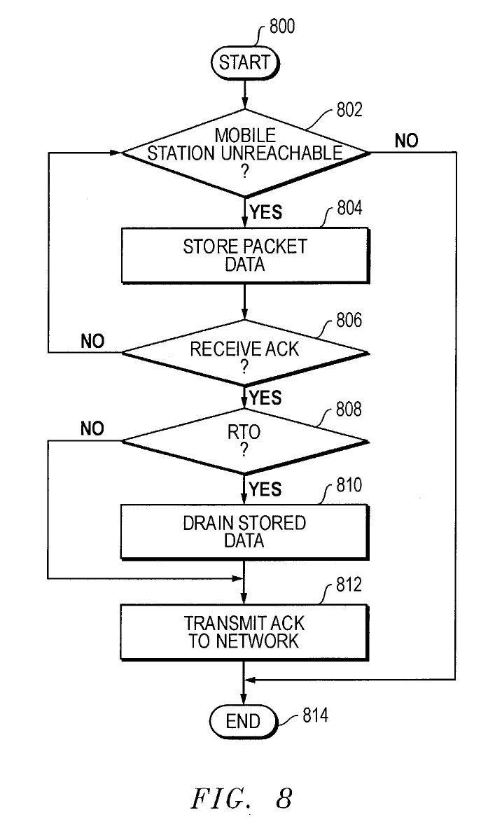

Referring now to FIG. 8, the “Drain The Packet” (DTP) function during retransmission is shown. The function begins with start 800. Next, the determination of whether the mobile station is reachable is made in step 802. If the mobile station is reachable, then the function continues with step 814 end. If the mobile station is unreachable, then the packet data received from the wired network is stored in step 804. Next, in step 806, whether an acknowledgment has been received from the mobile station on the last transmitted packet data is determined. If no acknowledgment has been received, then the process returns to step 802 and the packet data is continued to be stored in step 804. If an acknowledgment has been received in step 806, then a determination of whether the retransmission timeout has occurred in step 808. If the retransmission timeout has occurred in step 808, then the stored packet data is drained. If the retransmission timeout has not occurred, then the process continues with step 812 and the acknowledgment is transmitted to the wired network. The packet data stored in the wireless content switch is drained at step 810 because once a retransmission timeout has occurred, the wired network will retransmit the unacknowledged packet data regardless of the data stored at the wireless content switch. If the stored packet data is not drained, then this data will be sent to the mobile station along with the retransmission from the wired network causing excess transmission. If the retransmission timeout has not occurred, then the stored packet data is transmitted to the mobile station with the acknowledgment being retransmitted to the wired network. If the retransmission timeout has not occurred, then the wired network will not retransmit the stored packet data. The process ends with step 814.

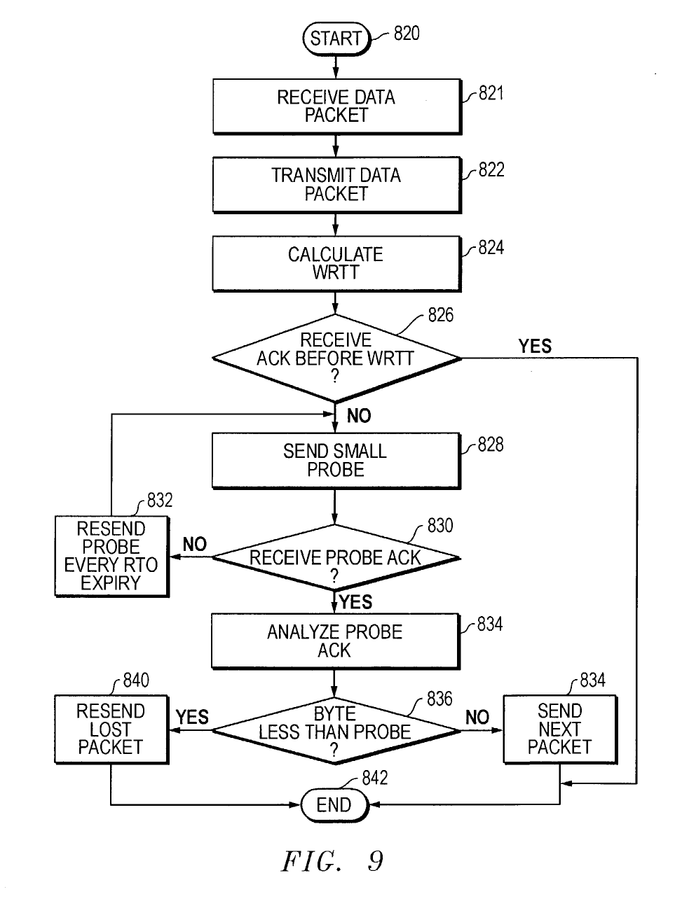

Referring now to FIG. 9, the optimized TCP function during retransmission is shown. The wireless content switch 115 only retransmits data packets when the data packet or associated acknowledgment is lost or experiencing an extended delay in the wireless network 120. When the data packet is lost or delayed, several options are available. The wireless content switch 115 could 1) wait for the retransmission timeout (RTO) to occur, then retransmit the lost data packet; 2) retransmit the data packet if the acknowledgment is not received within the expected RTT or WRTT; or transmit a small probe at the RTO/RTT/WRTT expiry. Case 1 results in lowered bandwidth utilization as the whole packet is transmitted every RTO. Case 2 results in excessive retransmissions due to RTT/WRTT variations based upon normal queuing delays which results in slower service. Case 3 optimizes on the tradeoffs between Case 1 and 2 and sends short probes at the RTO/RTT/WRTT expiry. This optimization is shown in FIG. 9.

The optimization function begins with start 820. Next, the wireless content switch 115 receives a data packet signal P(x) from the content source 105 in step 821. Responsive to this receiving the data packet, the wireless content switch 115 stores the data packet P(x) in memory and transmits the data packet P(x) to the mobile station 125 in step 822. As an optimization tool, the wireless content switch 115 calculates the wireless round trip time (WRTT) in step 824. The WRTT is the estimated time for the transmission and acknowledgment of data packets sent to the mobile station 125.

The WRTT is calculated as the measured round trip time (RTT) multiplied by a queuing delay factor. In one disclosed embodiment the following formula is used to calculate WRTT:

WRTT=C+(ceiling(MSS/LR))/Tₒᵤₜ*Nₘₐₓ*Tₒᵤₜ

Where the variable are defined as follows:

| | |
|---|---|
| C | Base RTT constant; is determined at the initial setup; |
| MSS | Maximum Segment Size in bytes; |
| LR | Leak Rate in bytes/sec; the LR is determined by the wireless |
| | network; |
| Tₒᵤₜ | Radio Link Control (RLC) timeout value; |
| Nmax | Maximum RLC retires. |

In another disclosed embodiment, the WRTT is calculated as follows:

RTT′=δ*Previous RTT′+(1−δ)*current RTT

WRTT=RTT′+4*σ

Where the variables are defined as follows:

| | |
|---|---|
| Current RTT | Measured RTT for the current transmission |
| RTT′ | Weighted average of the RTT including current RTT |
| Previous RTT′ | Previous weighted average of the RTT |
| δ | a configurable constant, typically set to 0.9 |
| σ | the standard deviation of the samples |

In another disclosed embodiment, the WRTT can be calculated as the observed RTT for the SYN packet signal plus 4 times the standard deviation of the acknowledgment intervals.

Various other WRTT calculations are available and can be implemented without detracting from the spirit of the invention.

Once the WRTT is determined in step 824, the wireless content switch 115 determines, in step 826, if the acknowledgment A(x) of the transmitted packet P(x) has been received prior to the WRTT time or the RTO expiry. If the acknowledgment A(x) has been received, the process ends with End in step 842. If the WRTT is exceeded or an RTO expiry has occurred, the wireless content switch 115 sends a small probe to the mobile station 125 with a sequence number equal to the last sequence number sent to the mobile station in step 828. The small probe can include 0 bytes or include the 1^{st} byte of the last unacknowledged data packet P(x). Next, in step 830, the wireless content switch 115 determines if the small probe is acknowledged. If the small probe is not acknowledged, the wireless content switch 115 resends the small probe every RTO expiry in step 832. In an alternate embodiment, the wireless content switch 115 resends the small probe following an exponential backoff of the RTO. If the wireless content switch 115 received an acknowledgment to the small probe, the wireless content switch analyzes the content of the acknowledgment in step 834. Next, in step 836, the wireless content switch determines if the acknowledgement is an acknowledgment of the byte less than the probe sequence number. If the acknowledgment is an acknowledgment of byte less than the probe sequence number, then the data packet P(x) is resent in whole to the mobile station 125 in step 840 before ending in End at step 842. If the acknowledgment is for the entire data packet P(x), then the wireless content switch transmits the next data packet P(x+1) to the mobile station in step 838. The process ends with step 842.

Through this optimization scheme, the total packet delivery over the wireless network 120 is reduced. The small probe requires considerably less bandwidth than the retransmission of the data packet P(x). Therefore, significant bandwidth was saved on the occasion that the acknowledgment A(x) was lost in the wireless network 120.

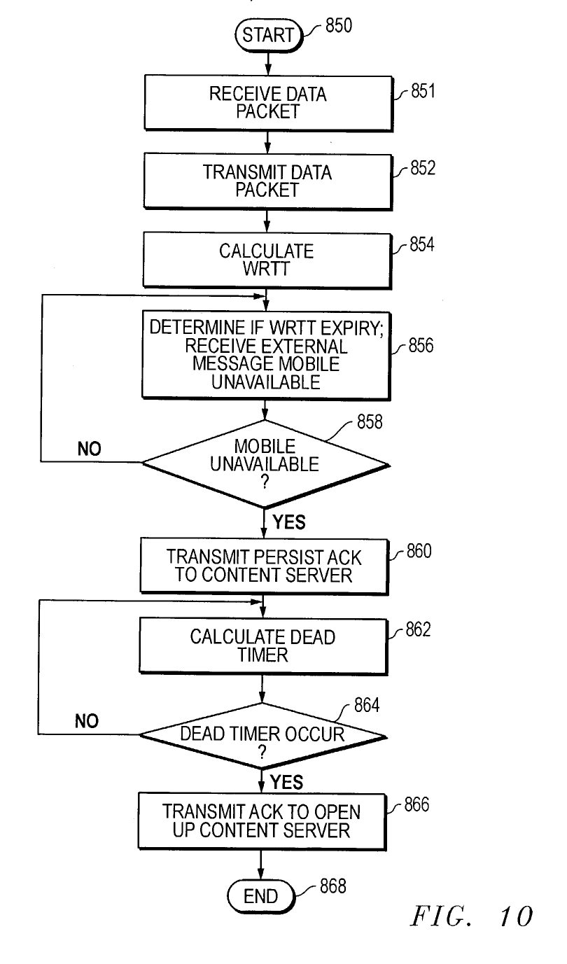

Referring now to FIG. 10, the persist server function during periods of mobile unavailability is shown. Optimization of the wireless network 120 may require that the content server 105 be placed in the persist mode. When the content server 105 is in the persist mode, the congestion control and avoidance mechanisms of the transmission control protocol are not invoked even though the time triggers are met. Relying solely on messages from the wireless network 120 to the content server 105 to place the content server 105 in persist mode may be untimely. If the content server 105 can be placed in persist mode at a point in time closer to the unavailability of the mobile station 125, quality of the wireless experience in increased. The wireless content switch 115 implements persist server functionality that closely aligns the disrupted air interface of the wireless network 120 with the transmission placing the content server 105 in persist mode. This functionality is shown in FIG. 10.

The function begins with start 850. Next, the wireless content switch 115 receives a data packet signal P(x) from the content source 105 in step 851. Responsive to this receiving the data packet, the wireless content switch 115 transmits the data packet P(x) to the mobile station 125 in step 852. As an optimization tool, the wireless content switch 115 calculates the wireless round trip time (WRTT) in step 254. The WRTT is calculated based upon the equations discussed herein. The wireless content switch 115, in step 856, determines if the WRTT has been exceeded, or if an external message regarding mobile unavailability has been received prior to receiving an acknowledgment from the mobile station 125 in response to data packet P(x). External messages include the radio status message or suspend message transmitted from the wireless network 120 to the wireless content switch 115. If the WRTT has not been exceeded in step 858, the wireless content switch 115 continues to monitor the WRTT in step 856. If the WRTT has been exceeded or the wireless content switch 115 has received an external mobile unavailable message, the wireless content switch transmits an acknowledgment to the content server 105 in step 860. This acknowledgment is sent with the advertised window size set to zero (0) and with the sequence number of the last acknowledged packet. When the content server 105 receives this acknowledgment, the content server 105 is placed into the persist mode. While in the persist mode, the content server will not invoke congestion control and avoidance mechanisms of the transmission control protocol.

Once the content server 105 is in the persist mode, the wireless content switch 115 calculates and executes a dead timer in step 862. The dead timer is used to recover from abnormal situations, including extending unavailability of the mobile station. In one disclosed embodiment, the dead timer is calculated using a 10 second timer. The timer functions are available with most computer systems and are well known to those skilled in the art. A dead timer event occurs when the timer expires. Next, in step 864 the wireless content switch 115 determines if the dead timer event has occurred. The dead timer event occurs when the timer has completed the count-down. If the dead timer event has not occurred, the wireless content switch continues to monitor the dead timer in step 862. If the dead timer event has occurred, the wireless content switch 115, in step 866, transmits an acknowledgment to the content server 105. This acknowledgment includes a sequence number of one less than the last transmitted packet number (P(x−1)). This acknowledgment opens up the content server 105, removing it from the persist mode. The content server 105 will then continue with its congestion control and avoidance mechanisms. The process ends with End is step 868.

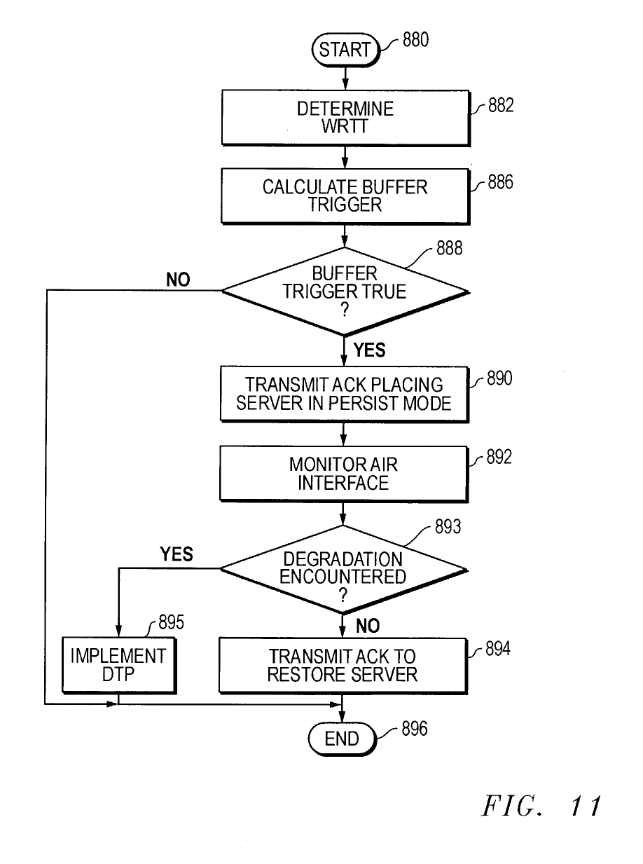

Referring now to FIG. 11, the buffer trigger rate regulation function during retransmission is shown. If there has been a sudden degradation in the air interface throughput (leak rate) of the wireless network, the base station controller's (BSC), the station that actually transmits the air-based signal to the mobile station, incoming data rate could exceed the current leak rate. The in-flight data packets could exceed the default bucket size of the BSC and cause an overflow. To avoid this possibility, the in-flight data packets need to be limited to at or below the default bucket size threshold. By decreasing unnecessary retransmissions of data packets, the goodput of the wireless network 120 is increased. The rate regulation functionality is disclosed in FIG. 11.

The function begins with start 880. During the transmission and reception of data packets and acknowledgments, the wireless content switch 115 determines the WRTT in step 882. The WRTT is determined based upon the equations disclosed herein. Next, in step 886, the wireless content switch 115 calculates the buffer trigger (BT). The buffer trigger is calculated based upon the following equations:

BT=True if (P_{k,s}−Aₖ₋₁)>=(Bₘₐₓ+CLR*WRTT)

else, BT is False

Up_{—}AdvWin=max(Bₘₐₓ, min(Mo_{—}AdvWin, CLR*WRTT))

Where the variable are defined as follows:

| | |
|---|---|
| BT | Buffer Trigger; |
| P_{k,s} | Packet number of 1^{st} byte of next transmitted packet; |
| Aₖ₋₁ | Packet number of last received acknowledgment; |
| Bₘₐₓ | Default bucket size of the BSC; |
| CLR | Current Leak Rate; the LR is determined by the |
| | wireless network; |
| WRTT | Wireless Round Trip Time; |
| Up_AdvWin | Transmitted window size; and |
| Mo_AdvWin | Mobile Station window size. |

Next, in step 888, the wireless content switch 115 determines if the buffer trigger is True. If the buffer trigger is False, the next data packet transmitted would not cause an overflow and the process ends with step 896. If the buffer trigger is True, then the next data packet to be transmitted could cause an overflow if the air interface of the wireless network 120 would become degraded. Next, in step 890, the wireless content switch 115 transmits an acknowledgment to the content server 105, placing the content server in persist mode. The wireless content switch 115 then monitors the air interface in step 892 to determine if the degradation problem is encountered, step 893. If the degradation problem is encountered, the wireless content switch 115 implements the drain the packet (DTP) functionality in step 895. The DTP function is disclosed in association with FIG. 8. If the air interface degradation problem is not resolved, the wireless content switch 115 restores the content server with an acknowledgment signal in step 894 with the window size set to Up_AdvWin. The process ends with step 896.

Referring now to FIG. 12, the expedited congestion window increase function during retransmission is shown. When the content server 105 has timed out due to the lack of an acknowledgment to a previously sent data packet, the content server 105 invokes congestion control and avoidance mechanisms and decreases the transmission window size and then retransmits the lost packets in the proper order at a significantly slower rate. The content server 105 continues transmission with the reduced window size until the content server 105 receives acknowledgments of the retransmitted packets. As the acknowledgements are received, the content server 105 slowly increases the window size on the next data packet transmissions. The expedited congestion window increase functionality significantly accelerates the timing of the window increases and is shown in FIG. 12.

The function begins with start 900. The wireless content switch 115 receives data packets from the content source 105 in step 902. Next, in step 904, the wireless content switch 115 transmits the data packets to the mobile station 125. The wireless content switch then monitors for the receipt of the acknowledgments of the data packets in step 906. If a lost data packet or acknowledgment is detected in step 908, the wireless content switch 115 executes the retransmission functionality disclosed herein to correct the lapse in transmissions. After the lost data packet or acknowledgment has been corrected, the wireless content switch 115 receives a cumulative acknowledgment signifying that the lost packet or acknowledgment has been properly received in step 912.

A cumulative acknowledgment is an acknowledgment signifying that multiple data packets have been received. For example, if P(x), P(x+1) and P(x+2) were transmitted to the mobile station 125 and the mobile station only received P(x+1) and P(x+2), the mobile station would respond by transmitting an acknowledgment, A(x−1) to the wireless content switch 115 signifying that P(x) has not been received. After P(x) has been retransmitted, the mobile station 125 transmits a single acknowledgment, A(x+2) to the wireless content switch 115. This acknowledgment signifies that all data packets through P(x+2) have been received. This acknowledgment is a cumulative acknowledgment as it signifies that data packets P(x), P(x+1) and P(x+2) were received.

Next, in step 914, the wireless content switch 115 determines if the content server 105 has invoked congestion control and avoidance mechanisms due to the delayed transmittal of the acknowledgments. If the content server 105 has not invoked congestion control and avoidance mechanisms, the wireless content switch 115 transmits the cumulative acknowledgment to the content server 105 in step 916 before ending the process at step 920. If the content server 105 invoked congestion control and avoidance mechanisms, the wireless content switch 115 transmits multiple acknowledgments, one for each segment size worth of data, to the content server 105. This multiple acknowledgment transmittal expeditiously increases the window size of the transmittals from the content source 105. In further of the previous example, the wireless content switch 115 would transmit three (3) acknowledgments, A(x), A(x+1) and A(x+2) to the content source 105 instead of the one cumulative acknowledgment. The process ends with End in step 920.

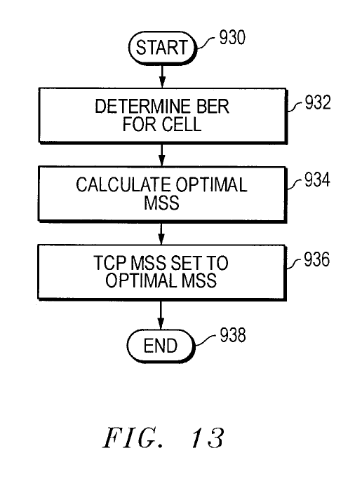

Referring now to FIG. 13, the improved goodput function during packet transmission is shown. The function begins with start 930. The Bit Error Rate (BER) for a particular wireless cell is determined in step 932. The BER value is provided to the wireless content switch 115 by the wireless network. Next, in step 934, the optimal Maximum Segment Size (MSS) for transmissions to the mobile station 125 is calculated. When the MSS is optimized, the probability of the data packet being received by the mobile station 125 is increased, therefore increasing goodput. The optimized MSS is calculated to be a value less than or equal to the BER. The optimized MSS is calculated according to the following equation:

(IP+TCP)Hds+2(#RLC Hds/MSS)+40(#RLC Fms/MSS)<=BER

Where the variable are defined as follows:

| | |
|---|---|
| IP + TCP Hds | Size of IP and TCP headers in each packet; |
| # RLC Hds | Size of Radio Link Control headers in each packet; |
| MSS | Maximum Segment Size; |
| # RLC Fms | Size of Radio Link Control frames; |
| BER | Bit Error Rate |

This calculation is illustrated in the following example:

Optimal RLC frames/MSS=x or MSS=40*x B=320*x b

BER=1 in 3200 b (with RLC retransmissions)

IP+TCP headers=40B=320b

RLC header=2*x B=16x b

320+16x+320x<=3200

336x<=2880

x<=8.57

MSS=40x=8*40=320B

Next, in step 936, the TCP MSS is set to the calculated optimal MSS. In furtherance of the example, the TCP MSS would be set to 320 Bytes. The process ends in step 938.

Although the foregoing detailed description describes certain embodiments with a degree of specificity, it should be noted that the foregoing embodiments are by way of example, and are subject to modifications, substitutions, or alterations without departing from the spirit or scope of the invention. For example, one embodiment can be implemented as sets of instructions resident in a memory, such as memory 155, 170, 175, or 185. Those skilled in the art will recognize that physical storage of instructions physically changes the medium upon which it is stored electronically, magnetically, or chemically so that the medium carries computer readable information. Accordingly, the invention is only limited by the following claims, and equivalents thereof.

What is claimed is:

1. A wireless content switch for transmitting and receiving data packets and acknowledgments, said wireless content switch comprising:
an upstream port for receiving one or more data packets and for transmitting one or more acknowledgments to a content source;
a downstream port for transmitting the one or more data packets and for receiving one or more acknowledgments from a mobile station;
at least one processing unit coupled to the upstream and down stream ports;
memory for storing the one or more data packets responsive to receiving the data packets; and
optimization code stored in the memory, the optimization code, when executed, performing the steps of:
receiving at least one data packet at the upstream port;
transmitting the data packet via the downstream port;
calculating a data packet round trip time;
determining if expiration of round trip time occurred prior to reception of acknowledgment for data packet;
if expiration of round trip time occurred, transmit a probe via the downstream port;
determine if receive probe acknowledgment; and
if no probe acknowledgment received, retransmit probe at fixed interval.

2. The wireless content switch of claim 1 wherein the step of retransmitting the probe at a fixed interval includes retransmitting the probe at the retransmission timeout expiry.

3. The wireless content switch of claim 1, further comprising optimization code, when executed, performing the step of:
if probe acknowledgment received, transmit requested data packet.

4. The wireless content switch of claim 3 wherein the step of transmitting requested data packet includes the following steps:
determining if the probe acknowledgment acknowledges a byte less than the probe sequence number;
if the byte acknowledged is less than the probe sequence number, retransmit the data packet; and
if the byte acknowledged is not less than the probe sequence number, transmit the next data packet received.

5. The wireless content switch of claim 4 wherein the step of determining if the probe acknowledgment acknowledges a byte less than the probe sequence number includes determining if the probe acknowledgment acknowledges the entire data packet.

6. The wireless content switch of claim 1 wherein the step of calculating the round trip time includes calculating the wireless round trip time (WRTT).

7. The wireless content switch of claim 6 wherein the step of calculating the WRTT includes calculating the measured round trip times multiplied by a queuing delay.

8. The wireless content switch of claim 1 wherein the step of transmitting a probe includes transmitting a small probe.

9. In a packet data network comprising a wired network and a mobile station, a method of optimizing retransmission functions, the method comprising:
receiving at least one data packet from the wired network;
storing the data packet;
transmitting the data packet to the mobile station;
calculating a round trip time for the data packet;
determining if the acknowledgment for the data packet is received prior to the expiration of the round trip time;
if the acknowledgment is not received, transmitting a probe to the mobile station; and
responsive to receiving an acknowledgment to the transmitted probe, transmitting the requested data packet.

10. The method of claim 9 wherein the step of calculating the round trip time includes calculating the wireless round trip time (WRTT).

11. The method of claim 10 wherein the step of calculating the wireless round trip time includes calculating the round trip time multiplied by a queuing delay.

12. The method of claim 9 wherein the step of transmitting a probe to the mobile station includes transmitting a probe with a sequence number equal to the last sent sequence number.

13. The method of claim 12 wherein the step of step of transmitting a probe to the mobile station includes transmitting a small probe.

14. The method of claim 9, further comprising the step of:
if no acknowledgment is received for the probe, retransmitting the probe at a fixed interval.

15. The method of claim 14 wherein the step of retransmitting the probe at the fixed interval includes retransmitting the probe at the expiry of the retransmission timeout.

16. The method of claim 9, wherein the step of transmitting the requested data packet includes retransmitting the data packet.

17. The method of claim 16, wherein the step of retransmitting the data packet includes retransmitting the data packet in response to a probe acknowledgment of a byte less than the probe sequence number.

18. The method of claim 9, wherein the step of transmitting the requested data packet includes transmitting the next data packet.

19. The method of claim 18, wherein the step of transmitting the next data packet includes transmitting the next data packet in response to a probe acknowledgment of the data packet.

20. A wireless content switch for persisting a content source during periods of a mobile station unavailability, said wireless content switch comprising:
an upstream port for receiving one or more data packets and for transmitting one or more acknowledgments to the content source;
a downstream port for transmitting the one or more data packets and for receiving one or more acknowledgments from the mobile station;
at least one processing unit coupled to the upstream and down stream ports;
memory for storing the one or more data packets responsive to receiving the data packets; and
persist code stored in the memory, the persist code, when executed, performing the steps of:
receiving at least one data packet at the upstream port;
transmitting the data packet via the downstream port;
calculating a data packet round trip time;
determining if expiration of round trip time occurred or an external mobile unavailable message is received;
if expiration of round trip time occurred or the mobile is unavailable, transmitting a persist acknowledgment via the upstream port;
calculating and executing a dead timer;
determining if a dead timer event has occurred; and
if a dead timer event has occurred, transmitting an open acknowledgment via the upstream port.

21. The wireless content switch of claim 20 wherein the step of calculating the round trip time includes calculating the wireless round trip time (WRTT).

22. The wireless content switch of claim 21 wherein the step of calculating the WRTT includes calculating the measured round trip times multiplied by a queuing delay.

23. The wireless content switch of claim 20 wherein the step of determining if an external mobile unavailable message is received includes determining if a radio status message is received.

24. The wireless content switch of claim 20 wherein the step of determining if an external mobile unavailable message is received includes determining if a suspend message is received.

25. The wireless content switch of claim 20 wherein the step of transmitting a persist acknowledgment via the upstream port includes transmitting an acknowledgment with the window size set to zero (0).

26. The wireless content switch of claim 20 wherein the step of transmitting a persist acknowledgment via the upstream port includes transmitting an acknowledgment with the sequence number of the last acknowledged data packet.

27. The wireless content switch of claim 20 wherein the step of executing the dead timer includes executing a computer based system timer

29. he wireless content switch of claim 20 wherein the step of transmitting an open acknowledgment via the upstream port includes transmitting an acknowledgment with the sequence number one less than the last acknowledged data packet.

29. In a packet data network comprising a wired network and a mobile station, a method of persisting the server, the method comprising:
receiving at least one data packet from the wired network;
transmitting the data packet to the mobile station;
calculating a round trip time for the data packet;
determining if the round trip time has expired or an external mobile unavailable message is received;
if expiration of round trip time occurred or the mobile is unavailable, transmitting a first acknowledgment to the wired network;
calculating and executing a dead timer;
determining if a dead timer event has occurred; and
if a dead timer event has occurred, transmitting a second acknowledgment to the wired network.

30. The method of claim 29 wherein the step of calculating the round trip time includes calculating the wireless round trip time (WRTT).

31. The method of claim 30 wherein the step of calculating the WRTT includes calculating the measured round trip times multiplied by a queuing delay.

32. The method of claim 29 wherein the step of determining if an external mobile unavailable message is received includes determining if a radio status message is received.

33. The method of claim 29 wherein the step of determining if an external mobile unavailable message is received includes determining if a suspend message is received.

34. The method of claim 29 wherein the step of transmitting a first acknowledgment includes transmitting an acknowledgment with the window size set to zero (0).

35. The method of claim 29 wherein the step of transmitting a first acknowledgment includes transmitting an acknowledgment with the sequence number of the last acknowledged data packet.

36. The method of claim 29 wherein the step of executing the dead timer includes executing a computer based system timer.

37. The method of claim 29 wherein the step of transmitting a second acknowledgment includes transmitting an acknowledgment with the sequence number one less than the last acknowledged data packet.

38. A wireless content switch for regulating the rate of data packet transmissions to a mobile station, said wireless content switch comprising:
an upstream port for receiving one or more data packets and for transmitting one or more acknowledgments to a content source;
a downstream port for transmitting the one or more data packets and for receiving one or more acknowledgments from a mobile station;
at least one processing unit coupled to the upstream and down stream ports;
memory for storing the one or more data packets responsive to receiving the data packets; and
rate regulation code stored in the memory, the rate regulation code, when executed, performing the steps of:
receiving at least one data packet at the upstream port;
transmitting the data packet via the downstream port;
calculating a buffer trigger;
determining if buffer trigger is met;
if buffer trigger is met, transmitting a first acknowledgment to the content source;
monitoring air interface to the mobile station;
determining if air interface degradation is encountered;
if degradation encountered, implementing the drain the packet functionality; and
if no degradation encountered, transmitting a second acknowledgment to the content source

39. The wireless content switch of claim 38 wherein the step of calculating a buffer trigger further comprises determining if the last data packet transmitted to the mobile station minus the last data packet acknowledged from the mobile station is greater than the sum of the default bucket size plus the wireless round trip time multiplied by the current leak rate.

40. The wireless content switch of claim 39 wherein the step of calculating the wireless round trip time includes calculating the measured round trip times multiplied by a queuing delay.

41. The wireless content switch of claim 38 wherein the step of calculating a buffer trigger further comprises:
setting the buffer trigger according to the following equation:
BT=True if (P_{k,s}−Aₖ₋₁)>=(Bₘₐₓ+CLR*WRTT)
else, BT is False.

42. The wireless content switch of claim 38 wherein the step of transmitting a first acknowledgment to the content source includes transmitting an acknowledgment to the content source with the window size set to zero(0).

43. The wireless content switch of claim 38 wherein the step of transmitting a second acknowledgment to the content source includes transmitting an acknowledgment to the content source with the window size set to the calculated transmitted window size.

44. In a packet data network comprising a wired network and a mobile station, a method of rate regulation, the method comprising:
receiving at least one data packet from the wired network;
transmitting the data packet to the mobile station;
calculating a buffer trigger;
determining if buffer trigger is met;
if buffer trigger is met, transmitting a persist server acknowledgment to the wired network;
monitoring air interface to the mobile station;
determining if air interface degradation is encountered;
if degradation encountered, implementing the drain the packet functionality; and
if no degradation encountered, transmitting a restore server acknowledgment to the wired network.

45. The method of claim 44 wherein the step of calculating a buffer trigger further comprises determining if the last data packet transmitted to the mobile station minus the last data packet acknowledged from the mobile station is greater than the sum of the default bucket size plus the wireless round trip time multiplied by the current leak rate.

46. The method of claim 45 wherein the step of calculating the wireless round trip time includes calculating the measured round trip times multiplied by a queuing delay.

47. The method of claim 44 wherein the step of calculating a buffer trigger further comprises:
setting the buffer trigger according to the following equation:
BT=True if (P_{k,s}−Aₖ₋₁)>=(Bₘₐₓ+CLR*WRTT)
else, BT is False.

48. The method of claim 44 wherein the step of transmitting a persist server acknowledgment includes transmitting an acknowledgment with the window size set to zero(0).

49. The method of claim 44 wherein the step of transmitting a restore server acknowledgment includes transmitting an acknowledgment with the window size set to calculated transmitted window size.

50. A wireless content switch for expedited congestion window increases at a content server during retransmissions of data packets to a mobile station, said wireless content switch comprising:
an upstream port for receiving one or more data packets and for transmitting one or more acknowledgments to the content server;
a downstream port for transmitting the one or more data packets and for receiving one or more acknowledgments from the mobile station;
at least one processing unit coupled to the upstream and down stream ports;
memory for storing the one or more data packets responsive to receiving the data packets; and
expedited congestion window code stored in the memory, the expedited congestion window code, when executed, performing the steps of:
receiving at least two data packets at the upstream port;
transmitting the data packets via the downstream port;
monitoring acknowledgments from the mobile source;
detecting a lost data packet or lost acknowledgment;
executing retransmission of detected data packet;
receiving cumulative acknowledgment, wherein the cumulative acknowledgment represents the retransmitted data packet and all other received data packets prior to the reception by the mobile station of the retransmitted packet;
determining if the content server has timed out;
if the content server has not timed out, transmitting the cumulative acknowledgment to the content server; and
if the content server has timed out, separating the cumulative acknowledgment in to single data packet acknowledgments and transmitting the individual single data packet acknowledgments to the content server.

51. The wireless content switch of claim 50 wherein the step of detecting lost data packets or lost acknowledgments includes determining if the length of time for an acknowledgment is greater than the wireless round trip time.

52. The wireless content switch of claim 51 wherein the step of calculating the wireless round trip time includes calculating the measured round trip times multiplied by a queuing delay.

53. The wireless content switch of claim 50 wherein the step of determining if the content server has timed out includes determining if the content server has implemented congestion control and avoidance mechanisms.

54. The wireless content switch of claim 50 wherein the step of determining if the content server has implemented congestion avoidance mechanisms includes determining if the content server has decreased window sizes of data packets.

55. In a packet data network comprising a content server and a mobile station, a method of expedited congestion window increases, the method comprising:
receiving at least two data packets from the content server;
transmitting the data packets to the mobile station;
monitoring acknowledgments from the mobile source;
detecting a lost data packet or lost acknowledgment;
executing retransmission of detected data packet;
receiving cumulative acknowledgment, wherein the cumulative acknowledgment represents the retransmitted data packet and all other received data packets prior to the reception by the mobile station of the retransmitted packet;
determining if the content server has timed out;
if the content server has not timed out, transmitting the cumulative acknowledgment to the content server; and
if the content server has timed out, separating the cumulative acknowledgment in to single data packet acknowledgments and transmitting the individual single data packet acknowledgments to the content server.

56. The method of claim 55 wherein the step of detecting a lost data packet or lost acknowledgment includes determining if the length of time for an acknowledgment is greater than the wireless round trip time.

57. The method of claim 56 wherein the step of calculating the wireless round trip time includes calculating the measured round trip times multiplied by a queuing delay.

58. The method of claim 55 wherein the step of determining if the content server has timed out includes determining if the content server has implemented congestion control and avoidance mechanisms.

59. The method of claim 55 wherein the step of determining if the content server has implemented congestion avoidance mechanisms includes determining if the content server has decreased window sizes of data packets.

60. A wireless content switch for increased goodput in a cell of a wireless network during transmissions of data packets to a mobile station present in the cell, said wireless content switch comprising:
an upstream port for receiving one or more data packets and for transmitting one or more acknowledgments to the content server;
a downstream port for transmitting the one or more data packets and for receiving one or more acknowledgments from the mobile station;
at least one processing unit coupled to the upstream and down stream ports;
memory for storing the one or more data packets responsive to receiving the data packets; and
increased goodput code stored in the memory, the increased goodput code, when executed, performing the steps of:
determining bit error rate (BER) for the cell;
calculating the optimal maximum segment size (MSS);
setting Transmission Control Protocol (TCP) MSS to optimal MSS;
receiving at least one data packet at the upstream port;
transmitting the data packet via the downstream port; and
monitoring acknowledgments from the mobile source.

61. The wireless content switch of claim 60 wherein the step of determining bit error rate for the cell includes receiving the bit error rate for the cell from the wireless network.

62. The wireless content switch of claim 60 wherein the step of calculating the optimal maximum segment size (MSS) includes calculating an optimal maximum segment size less than the bit error rate.

63. The wireless content switch of claim 62 wherein the step of calculating the optimal maximum segment size (MSS) includes calculating an optimal maximum segment size according to the following equation:
(IP+TCP)Hds+2(#RLC Hds/MSS)+40(#RLC Fms/MSS)<=BER

64. In a packet data network comprising a cell and a mobile station of a wireless network and a wired network, a method of increased goodput, the method comprising:
determining bit error rate (BER) for the cell;
calculating the optimal maximum segment size (MSS);
setting Transmission Control Protocol (TCP) MSS to optimal MSS;
receiving at least one data packet from the wired network;
transmitting the data packet to the mobile station; and
monitoring acknowledgment from the mobile source.

65. The wireless content switch of claim 64 wherein the step of determining bit error rate for the cell includes receiving the bit error rate for the cell from the wireless network.

66. The wireless content switch of claim 64 wherein the step of calculating the optimal maximum segment size (MSS) includes calculating an optimal maximum segment size less than the bit error rate.

67. The wireless content switch of claim 66 wherein the step of calculating the optimal maximum segment size (MSS) includes calculating an optimal maximum segment size according to the following equation:
(IP+TCP)Hds+2(#RLC Hds/MSS)+40(#RLC Fms/MSS)<=BER.
